(19) United States
(12) Patent Application Publication
(10) Pub. No.: US 2015/0278772 A1
(43) Pub. Date: Oct. 1, 2015

(54) Supporting a Post-Installation Deployment of Components of Equipment

(71) Applicants: Roland Eckl, Forchheim (DE); Manfred Langen, Munchen (DE)

(72) Inventors: Roland Eckl, Forchheim (DE); Manfred Langen, Munchen (DE)

(21) Appl. No.: 14/227,898

(22) Filed: Mar. 27, 2014

(51) Int. Cl. G06Q 10/00; G06Q 30/00

(52) U.S. Cl. CPC G06Q 10/20; G06Q 30/012

(57) ABSTRACT

A method, by which a life-cycle data of a component is obtained, is provided. The life-cycle data is indicative of one or more factors occurring during a life-cycle of the component and affecting a length of the life-cycle of the component. The life-cycle of the component is assessed in a context of at least parts of the equipment in which the component is installed. Properties of the component including an assessed life-cycle are registered in an exchange system. The exchange system is configured for supplying components. The components are at least specified by a life-cycle and an operating environment.

### TECHNICAL FIELD

The disclosed embodiments relate to a method and system for supporting a post-installation deployment of components of an item of equipment.

### BACKGROUND

In various industries, manufactured equipment may include any number of components that are life-cycle limited, whether by engineering design or by regulatory directive. In some cases, life-limited components may be installed on different equipment, and a variety of different entities may direct with or operate on these components over their lifetimes.

Equipment refers to any device, apparatus, or assembly that requires maintenance or provides improved performance or greater longevity upon receipt of such maintenance. Equipment may be any mechanical equipment, any electrical equipment, any data processing system, any electronics or optical equipment, any software associated with mechanical equipment, electrical equipment, electronic equipment or a data processing system. A component may represent a part, an assembly of parts, a sub-assembly of a part, an element, or another constituent of equipment. A component may include, but need not include, one or more sub-components.

Known predictive maintenance schemes provide schedules for replacing or repairing one or more components at various times to minimize the downtime of the equipment. Besides the life-cycle limitation of particular components, the decision of what components to replace and when to replace components may be based upon a factor that relates to an operating environment. The operating environment may include safety-critical requirements or quality performance standard imposed on equipment or components of the equipment.

### SUMMARY AND DESCRIPTION

The scope of the present invention is defined solely by the appended claims and is not affected to any degree by the statements within this summary.

A need exists for considering historical life-cycle data of individual components. As a result of economic and ecological considerations, an option to change and dispose of components may be dismissed in favor of reusing components. However, a reuse of life-limited components is to comply with the operating environment of the subsequent deployment and may include safety-critical requirements or quality performance standards imposed on equipment or components of the equipment.

Although a component reaching a life-cycle may no longer comply with a specified operating environment of first equipment, in which the component is installed, the component may, however, comply with a specified operating environment of second equipment (e.g., in cases where safety-critical requirements or quality performance standard imposed on the second equipment are lower than those of the first equipment).

Accordingly, there is a need in the art for supporting a post-installation deployment of components of an item of equipment.

Systems and methods in accordance with various embodiments provide for supporting a post-installation deployment.

In one embodiment, a method by which a life-cycle data of the component is obtained is provided. The life-cycle data is indicative of one or more factors occurring during a life-cycle of the component and affecting a length of the life-cycle of the component. The life-cycle of the component is assessed in a context of at least parts of the equipment in which the component is installed. Properties of the component including an assessed life-cycle are registered in an exchange system. The exchange system is configured for supplying components. The components at least specified by at least a life-cycle and an operating environment.

The life-cycle data may stay with the component during the entire life-cycle of the component. The life-cycle data facilitates the accumulation of life-cycle data per individual component as from the component being manufactured, including service data relating to transport, to storage or to other kinds of non-use, to operational use, to relocating, to refurbishment, to re-use, etc.

Accordingly, as a result of having life-cycle data accumulated over the life of the component, starting with manufacturing all the way up to the present, a more accurate prediction may be made regarding the residual life of the individual component at any point in the life-cycle.

### BRIEF DESCRIPTION OF THE DRAWINGS

FIG. 1 shows a flow diagram of one embodiment of a method; and

FIG. 2 shows a block diagram of one embodiment of equipment in communication with an exchange system.

### DETAILED DESCRIPTION

According to an embodiment, a method for supporting a post-installation deployment of components of equipment may include obtaining life-cycle data of the component, indicative of one or more factors occurring during a life-cycle of the component and affecting a length of the life-cycle of the component, and assessing the life-cycle of the component in a context of life-cycle data of at least one other component and of quality requirements of at least parts of the equipment in which the component is installed. The method also includes registering properties of the component including an assessed life-cycle of the component in an exchange system. The exchange system is configured for supplying components. The components are at least specified by a life-cycle and an operating environment.

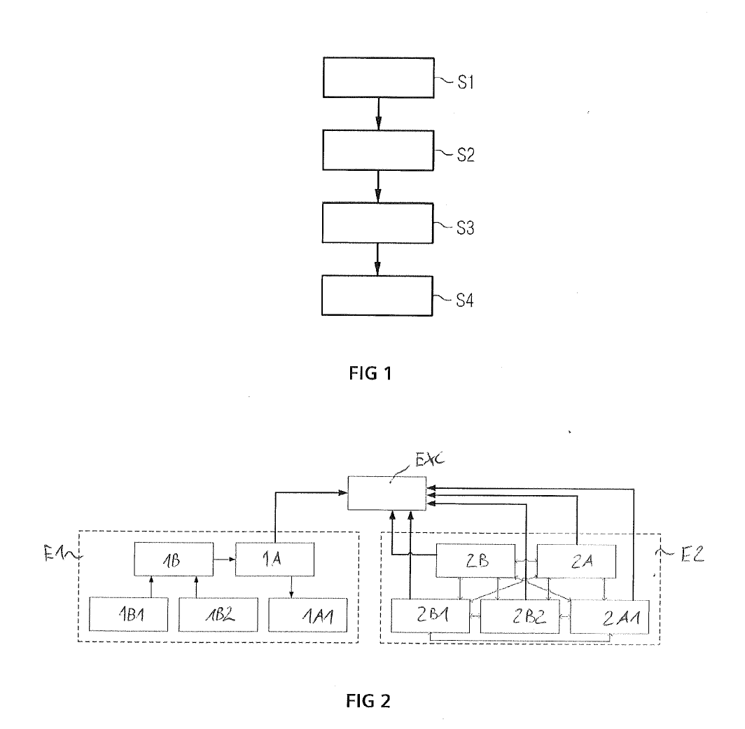

FIG. 1 shows a flow diagram of one embodiment of a method.

In act S1, life-cycle data of a component is obtained.

A particular component is identified by identification data of the component, which may include an identification number of the component (e.g., a unique identification number or a serial number associated with the component and included in the life-cycle data). The identification data may be representative of a machine-readable identifier for uniquely identifying the particular component. The machine-readable identifier may be applied to the particular component at the manufacturing of the particular component.

The life-cycle data includes one or more factors occurring during a life-cycle of the component and affecting a length of the life-cycle of the component. The life-cycle data may include one or more of the following: number of cycles of the component, a number of hours of usage, other usage measurement data associated with the component or the particular equipment in which the component is installed, a mean-time-between-failure (MTBF), etc. The life-cycle data may take into account the usage and performance of the equipment in an operational environment. The life-cycle data may include information relating to particular repairs, maintenance procedures, refurbishments, overhauls, and/or other instances of services applied to the component.

The life-cycle data may be gathered by a sensor or a person associated with the equipment, by the equipment, by a component of the equipment or otherwise.

The life-cycle data may define an interrelationship between components on the equipment. The life-cycle data may describe interrelationships and organization of the constituent components of the equipment.

The life-cycle data may also include location history records for indicating one or more physical locations where the component was located at various times in its life-cycles. The life-cycle data may also include one or more owners associated with the component, and remaining life records may indicate whether the life limited components have any permitted life remaining.

In act S2, the life-cycle of the component is assessed in a context of at least parts of the equipment in which the component is installed. This context may be determined by safety-critical requirements or quality performance standard imposed on equipment or parts of the equipment. During the life-cycle, the component meets or exceeds a threshold reliability criterion. The threshold reliability criteria may refer to a percentage of availability of the equipment or a component of the equipment.

Act S2 may assess the life-cycle for an assembly of components, a system of components of the equipment, or the entire equipment, rather than a single component. In other words, the probability of failure is associated with a component, a group of components, or the equipment as a whole.

The assessment in a context of at least parts of the equipment may be determined by safety-critical requirements or quality performance standard imposed on equipment or parts of the equipment. In other words, the life-cycle of a component may be determined by requirements imposed on equipment or parts of the equipment. While a component may reach the end of its life-cycle in a safety-critical equipment, a deployment within a redundant operating environment may be less critical in terms of the assessed life-cycle.

In act S3, properties of the component including its assessed life-cycle are registered in an exchange system. The exchange system is configured for supplying components, where the components are at least specified by life-cycle and operating environment of the components.

In an optional act S4, according to an embodiment, the exchange system is used with an enterprise resource planning system for supplying a post-installation deployment of the component.

The exchange system allows for a registration of properties of a component currently installed in equipment along with a context of quality requirements of at least parts of the equipment in which the component is installed. The context and properties may be mapped with a new context in an alternative operating environment constituting a marketplace for a post-installation deployment of components. The marketplace of the exchange system may range from a local organization (e.g., within an enterprise) to a global perspective.

Referring to FIG. 2, which shows a block diagram of a possible embodiment of equipment in communication with an exchange system, details of possible data flows are shown.

An exchange system EXC is a destination for a plurality of data flow depicted by an arrow.

The arrows of FIG. 2 illustrate the respective directions of data flow in the depicted system, although other directions of data flow may be provided. For example, in an alternate embodiment, the direction of the data flow may be bidirectional between various elements.

According to FIG. 2, the exchange system EXC is querying a first equipment E1 (e.g., component 1A of the first equipment E1). The exchange system EXC is further querying a second equipment E2 (e.g., components 2A, 2A1, 2B, 2B1, 2B2 of the second equipment E2).

While within the first equipment E1 the component 1A is working as a relay for other components or sub-components 1A1, 1B, 1B1, 1B2, the components 2A, 2A1, 2B, 2B1, 2B2 of the second equipment E2 may be queried directly.

The first embodiment shown for the first equipment E1 is advantageous in cases where not all components are able to establish a data flow with the exchange system EXC. The relaying component 1A may itself query a (sub-) component 1A1 as symbolized by an arrow in a direction from component 1A to component 1A1. The query architecture may be advantageous in case of communication restrictions (e.g., bandwidth or firewall restrictions).

The second embodiment shown for the second equipment E2 is advantageous in cases where components may communicate independently. The communication is, for example, provided by a peer-to-peer communication.

According to an embodiment, life-cycle data is machine-readably stored on a memory assigned to the component. In one embodiment, life-cycle data is queried in a wireless manner with the component. The memory may be integrated in a wireless autonomous device, such as those used in wireless sensor networks. As another option, the memory may be implemented in an RFID tag having circuitry that receives power from incident electromagnetic radiation generated by an external source (e.g., the querying reader of another component).

The embodiments proposed may be used in some exemplary cases described below.

In the case of a hard drive of a computer system reaching a life-cycle, the proposed method may support a post-installation deployment within a redundant array of independent disks (RAID) so that if individual components or even individual hard drives fail, the functionality of the RAID system is not affected. The proposed embodiments grant for optimum utilization of the service life of the hard drive.

A life-limited component of an aircraft reaching a specified life-cycle may not be replaced economically in view of the residual value of the aircraft. However, the component may be installed within an aircraft, to which less restriction on the life-cycle of this component is imposed. The proposed embodiments grant for economic re-usage in a new operation environment.

Instead of replacing a life-limited gear of a wind turbine by a new gear, the life-limited gear is replaced by a used gear exhibiting a sufficient remaining life. The re-usage of a component avoids expensive investments.

The elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for supporting a post-installation deployment of components of equipment, the method comprising:
obtaining life-cycle data of one of the components indicative of one or more factors occurring during a life-cycle of the one component and affecting a length of the life-cycle of the one component;
assessing the life-cycle of the one component in a context of quality requirements of at least parts of the equipment in which the one component is installed; and
registering properties of the one component including the assessed life-cycle in an exchange system, the exchange system configured for supplying the components, the components at least specified by a life-cycle and an operating environment.

2. The method of claim 1, further comprising communicating life-cycle data of at least one first component of the components to a second component of the components and obtaining the life-cycle data of the at least one first component by the second component.

3. The method of claim 1, wherein the life-cycle data of the one component is stored in a memory assigned to the one component.

4. The method of claim 1, wherein assessing the life-cycle data of the one component comprises assessing the life-cycle data of the one component in a context of life-cycle data of at least one other of the components.

5. The method of claim 1, further comprising using the exchange system with an enterprise resource planning system for supplying a post-installation deployment of the one component.

6. An exchange system for supporting a post-installation deployment of components of equipment, the exchange system comprising:
a memory configured to store:
a plurality of data entries related to a component, each entry of the plurality of data entries comprising identification data representative of a machine-readable identifier of the component;
a data set indicative of an equipment identifier, the equipment identifier identifying equipment in which the component is currently installed; and
a properties data set indicative of a life-cycle and an operating environment of the component; and
a processor in communication with the memory and configured to register properties of the component including the life-cycle.

7. A computer program product comprising program code stored on a non-transitory computer-readable storage medium, the program code, when executed on a computer, being configured to:
obtain life-cycle data of a component indicative of one or more factors occurring during a life-cycle of the component and affecting a length of the life-cycle of the component;
assess the life-cycle of the component in a context of life-cycle data of quality requirements of at least parts of the equipment in which the component is installed; and
register properties of the component including an assessed life-cycle in an exchange system, the exchange system configured for supplying components, the components at least specified by a life-cycle and an operating environment.

8. The computer program product of claim 7, wherein the program code, when executed on the computer, is further configured to communicate life-cycle data of at least one first component of the components to a second component of the components and obtain the life-cycle data of the at least one first component by the second component.

9. The computer program product of claim 7, wherein the life-cycle data of the component is stored in a memory assigned to the component.

10. The computer program product of claim 7, wherein the program code, when executed on the computer, is configured to assess the life-cycle data of the component, such that the life-cycle data of the component is assessed in a context of life-cycle data of at least one other of the components.

11. The computer program product of claim 7, wherein the program code, when executed on the computer, is further configured to use the exchange system with an enterprise resource planning system for supplying a post-installation deployment of the component.
